(19) United States
(12) Patent Application Publication
(10) Pub. No.: US 2008/0040768 A1
(43) Pub. Date: Feb. 14, 2008

(54) Approach for associating advertising supplemental information with video programming

(75) Inventor: Robert Elliott Robotham, Ottawa (CA)

Correspondence Address: KRAMER & AMADO, P.C., 1725 DUKE STREET, SUITE 240, ALEXANDRIA, VA, 22314, US

(73) Assignee: ALCATEL, Paris (FR)

(21) Appl. No.: 11/503,284

(22) Filed: Aug. 14, 2006

(51) Int. Cl. H04N 7/16; H04N 7/173

(52) U.S. Cl. 725/132; 725/136; 725/140

(57) ABSTRACT

Viewers of video programming are provided with a low effort mechanism to access product or service information related to a program being viewed. This benefits the viewers by providing them with only desired information, and advertisers of the products and services, by focusing their messages on their target market. The availability of advertising or other supplemental information is provided to the viewer within the programming, at places that are time-marked when the programming is being developed or in real time. In response to receiving a request from the viewer for this information, any information associated with the time marker is delivered to the viewer.

### FIELD OF THE INVENTION

The invention is directed to communication networks and in particular to ways of associating supplemental information with video programming.

### BACKGROUND OF THE INVENTION

Television commercial messages (commercials, advertisements or ads) have become a common way to advertise products, manufacturers, services, politicians, charities, etc. on behalf of their sponsors. In the traditional video advertising model, the services providers deliver entertainment content and ads to the consumers (viewers) with a view to induce the consumers that watch the entertainment content to buy the advertised products/services. Typically, the service provider may charge the consumers for the entertainment content delivery but receives most revenue from the product/service promoters in exchange for delivering ads with the entertainment content.

Certain television commercials which are informative, educational or entertaining may be worth of retaining for future viewing and exploring. For example, certain television commercials may contain information of particular relevance to a certain user, such as sales data for a product/service of interest, historically significant political messages, or may be just entertaining and deserve re-viewing. Other commercials which may be bothersome and/or uninteresting to a viewer would most probably be ignored. In this case, the consumer changes the channel, walks away during the commercial breaks, or turns to less advertising-dependent entertainment forms such as premium channels that do not include commercials. In response to this behavior, technology advances in the area of video recording now include functionality for avoiding commercials, such as a commercial skip feature that causes a recorder to move forward 30 seconds during playback, or basic commercial detection during recording.

Furthermore, recent technological advancements, such as Internet, have caused an increase in possible entertainment outlets. As a result, it became more difficult for the TV services providers and advertisers to increase the number of consumers their ads reach; also, it became increasingly difficult to guarantee that consumers will watch, hear, read, or otherwise absorb or become exposed to the ads within the entertainment content. This trend has led to lower advertising fees and lower profits.

In addition, the traditional video advertising model does not provide the consumers with enough information about the products of interest. Just seeing a short clip with a product/service in the middle of a TV program does not necessarily provide enough information to generate a sale by themselves. A fraction of the audience who could be potential customers may not know how to perform a successful Internet search, and a further fraction may not be motivated enough to perform such a search or use other mechanism to gain more information. Furthermore, if an Internet search is performed, it may return results for competitor's products. And the presence of a product in a program does not necessarily mean that additional information is readily available—repeated unsuccessful searches due to wrong key-words, or misspelling of the product/company name will discourage further attempts. Still further, television advertising does not present the information in a helpful, practical or personalized way, in other words it is not inherently selective. Although an advertisement can be placed in a program which has been made for an audience with somewhat specific market characteristics, it is in generally difficult to target traditional television advertising.

The proportion of the audience which is thought to be genuinely interested in an advertisement varies by product category, but normally ranges from 20-40%. Therefore, the advertisement viewed by the other 60-80% of the audience, which are not prime candidates, represents a large amount of wasted spending by the advertiser.

Targeted advertising business model has emerged as a result, whereby the advertisers focus on delivering specific, personalized commercials to the consumers that meet a demographic profile based on estimating audience characterization, or profiling. Attempts to target advertising accurately towards the consumers are based on fine grained demographics for the region or by tracking viewing patterns, or a combination. Characterization of the audience facilitates a promoter pricing advertisement delivery at a level that accurately reflects value. However, audience characterization provides only estimates of which ads certain groups of consumers will accept; greater accuracy would likely require the cooperation of the viewer. But, most viewers are not eager to volunteer more personal information and are suspicious when information on their behavior is collected without their active participation. As a result accuracy is likely to remain limited and consumers of a targeted group may ignore or avoid the ads targeted for them, and not receive ads that might interest them.

Another conventional method for product/services video promotion is broadcasting this type of information over a “shopping channel”. However, conventional systems for organizing video content on these channels are not well tailored to emulating the shopping experience; while purchasing goods through a conventional communication network offers the luxury of shopping from home, the benefits of traditional shopping malls continues to draw shoppers.

Still another approach taken in broadcast video is product placement. In this method, products are visible during the program (e.g. a character drinking a particular soft drink or using a particular brand of computer). This requires that the advertised products/services have distinctive packaging and easily identifiable characteristics. Also, this method requires the advertisers to balance between the product being noticeable and being obviously pushed. And that balance may vary between viewers. That is, while some viewers may not notice the product allegedly being advertised, others could be annoyed by the placement. And there is a limit on the number of products that can be presented simultaneously, on the order of one. This approach is limited to products that already enjoy customer recognition, or else requires explicit mention, which may be suitable for certain programming types but otherwise tends to appear artificial. As well, without explicitly being part of the program, the amount of information available on a product is extremely limited.

It also known to embed advertising within the programming. This is dominant in the broadcast of sporting events, in which participants may use clothing and/or gear with advertising on it and the event may be surrounded by billboards showing advertising. Advertising may also be superimposed on the programming to appear part of the event field. This type of advertising tends to have similar limitations as described above, in terms of not being able to be customized, requiring viewer recognition and being limited in the amount of information that can be conveyed. The ability to superimpose images of advertisements onto otherwise live feeds has emerged allowing customization, though the other limitations remain.

Closed-captioning (CC) and alternate audio tracks are not particularly suited to advertising. Each CC or audio channel only provides a single stream of information, and provides “real time” information, with the program (i.e. the program needs to be running with the appropriate CC and/or audio channel selected). The amount of information provided in this scenario is limited to text or audio information, and is also limited by the amount of time available, i.e. during a half hour program each CC or alternate audio channel can only provide half an hour worth of product information. Furthermore, there is a practical limit on the number of CC and alternate audio channels available (at least for broadcast video programs). Advertising is present in closed captioning for the companies that sponsor the creation of the closed captioning of the program.

As a general note, independent of technology to bypass advertisements, people tend to develop resistance to advertising that is not relevant to them, which results in their “tuning out” advertising of any format. Novel formats of advertising may grab their attention for a period of time, however, consumers eventually become jaded and the effectiveness fades.

This effect does not apply if the viewer/consumer is actively looking for information on a particular product/subject. A need exists for enhancing viewer ability for selection and use of commercials, by designing a cost-effective, entertaining, rewarding, and effective way of enticing consumers to become immersed in on-demand ads to a level that stimulates a product purchase or achieves brand recognition.

There are forms of interactive video (including advertising) available from at least one service provider. The implementation used limits the interactivity points to what is implemented during content creation. This greatly limits the flexibility. The current implementations require the insertion of “metatags” into the media stream(s) to allow the identification of potential points of interactivity. This needs to occur at the time of content generation/encoding, changing or adding new points requires re-encoding. The production of interactive programming is appreciably more complex than conventional production—and can not be separated.

To summarize, some commercials may have an entertainment and educational value to some consumers, and in some instances, the consumers look forward to certain advertisement campaigns from specific manufacturers. However it is difficult or impossible to provide all information on a product that any potential customer may be interested in within a reasonable size of ad. The longer the ad, the greater the cost to the advertiser, the fewer number of ads that can be sold and the greater likelihood that some viewers will be annoyed. Obtaining the additional information that a customer may want before making a purchase requires effort that viewers may not take. Depending on the mechanism by which additional information is obtained, the potential customer may be exposed to competitive products and the advertisement could result in a sale for a competitor. The current methods and systems of pushing advertising at consumers are susceptible to viewer fatigue or outright counter-measures. Specifically pulling advertising is a cooperative exercise; however advertising intended to be pulled by the consumers is currently complex and expensive to produce at this time. Advertising content producers and program content producers need to cooperate in the production.

There is a need for an interactive method and system for selection and display of advertisements which are thus better suited to the individual consumer, in that the advertisements are selected by those consumers and thus are of interest, and they may provide sufficient information for the product being selected and viewed.

There is also a need for a cost-effective, low effort and effective way of product/service advertising, which enables consumer immediate access to sufficient product/service information related to a product/service of a commercial.

There is also a need to display the availability of advertising or other supplemental information to the viewer in accordance with the current location (time index) in the program that is being viewed.

### SUMMARY OF THE INVENTION

It is an object of the present invention to provide an improved method and system for delivering commercials to viewers of video content delivered via a video network with network interconnectivity features.

It is another object of the invention to provide viewers of video programming with a low effort mechanism to access commercial information of interest related to a program being viewed.

Accordingly, the invention provides a system for associating supplemental information with a program transmitted from a head end to a local server over a broadcast network, for distribution to consumer terminals, comprising at the local server: a table for maintaining an association between a SI location within in the program where supplemental information is available and a supplemental information link; a query processor for receiving a query from a consumer terminal and determining the time T of the query and identifying a consumer terminal (CT) that issued the query; and a supplemental information identifier for identifying in the table the supplemental information link based on the time of arrival of the query.

Also, the invention provides a method of associating supplemental information with a program transmitted from a head end to a local server over a broadcast network, for distribution to consumer terminals, comprising: maintaining a table with an association between a SI location within the program where supplemental information is available and a supplemental information link; receiving a query from a consumer terminal and determining the time of arrival of the query; identifying the consumer terminal that issued the query; and identifying in the table the supplemental information link based on the time of arrival of the query.

Still further, the invention is directed to a consumer terminal enabled with trick play capabilities for interactive access to supplemental information associated with a program transmitted from a head end to a local server over a broadcast network, comprising: a sender for transmitting a query for supplemental information; a receiver for receiving a supplemental information link in response to the query; means for storing the supplemental information link; and means for signaling to a source of the supplemental information to deliver the supplemental information that is associated with the supplemental information link.

Advantageously, the method and system of the invention provides a new type of video advertising model, which benefits the consumer/viewers by providing them only with desired information, and benefits the advertisers of the products and services by focusing their messages on their target market. In this “pull type of advertising” model of the invention the advertiser operates in cooperation with the potential customer rather than inconveniencing the viewers in general.

Thus, through the present invention, the consumer is given immediate access to any available information pertaining to an ad and determines right away if further information is not available. Viewers do not have their program intruded on by advertising—on the other hand if they would like more information on something they see, it may be available. As “links” to a product/service of interest are inserted by the advertisers, the consumer does not need to access a separate search engine, determine the correct search terms, decide if returned hits are for the item of interest and then repeat this operations until either information on the item is found or the viewer ascertains that there is no information available. Still further, as advertising that is pointed to by “links” will be viewed only by customers interested in learning more about the product; it is not necessary to make special efforts to grab the attention of reluctant viewers.

Through the present invention, the consumer is given the capability to “bookmark” points in the program for which they would like to access supplemental information. At any time after this, the consumer may return to these points to determine what supplemental information is available at that time, which may be different from what was available at the original time of program viewing. The consumer may explicitly revisit the program point (which does not necessarily require viewing the point of the program itself) for the latest supplemental information, or the system may signal to the consumer when supplemental information relevant to the customer's bookmarked locations is updated.

From the advertisers point of view, the video advertising business method of the invention enables the advertisers to monitor the consumers following advertising links, which in turn allows a clear charging model, such as for example “pay per click” or other models. In addition, it allows the video program producers/developers to sell advertising links to product manufacturers. Advertising links may also be provided to the distributor (i.e. IPTV provider) and may then be sold to local merchants.

Still a further advantage of the invention is that advertising supplemental information relating to products/services can be kept up to date and localized (i.e. supplemental information displayed may be chosen based on customer location).

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 illustrates a block diagram of the system according to the invention;

FIG. 2 shows the block diagram of an embodiment of the query processor; and

FIG. 3 illustrates an example of how the supplemental information for a commercial is correlated with the program and with a consumer query.

### DETAILED DESCRIPTION

With recent advances in digital transmission technology, subscriber television systems are now capable of providing much more than the traditional analog broadcast video. In implementing enhanced programming, the home communication terminal known as the set-top box (STB), has become an important computing device for accessing content services and navigating a user through a maze of available services. In addition to supporting traditional analog broadcast video functionality, digital STBs now also support an increasing number of two-way digital services such as video-on-demand and personal video recording (PVR).

In this specification, “consumer” refers to persons (recipients) who may use the advertiser's commodity or service, and absorb the content of the ads. The term “advertisers” refers to entities that prepare material relating to various products and services, with a view to induce the consumers to buy, use, or further promote the respective products/services. The term “content provider” includes the promoters that initiate, develop, and generate, entertainment content (programming) attracting many of the consumers. The term “service provider” includes the promoters who distribute entertainment content (programming) to the consumers, and integrate within the programming commercials provided by the advertisers. A single role as identified by these terms may be addressed by more than one entity, and a single entity may play more than one of the roles identified by these terms.

The term “supplemental information links” refers to the information that is displayed on a consumer terminal after a request to access supplemental information is made while watching the program. These links may be hierarchical e.g. indicating what subjects (e.g. information on actor, audio, vehicle, furniture . . . ) have supplemental information available at point of the program currently being viewed. The supplemental information links may then be selected to access the actual supplemental information. It is also possible to provide a consumer with the link to a really simple syndication (RSS) feed, which is a family of web feed formats specified in XML and used for web syndication. Web feeds provide web content or summaries of web content together with links to the full versions of the content, and other metadata. RSS, in particular, delivers this information as an XML file called an RSS feed, webfeed, RSS stream, or RSS channel. In addition to facilitating syndication, web feeds allow a website's frequent readers to track updates on the site using an aggregator.

The specification uses the term “supplemental information” for the information related to a product, person or a service that is made available to a consumer, and which is directly associated to a program being viewed. This term broadly refers to any type of information available to the public or provided by advertisers regarding a respective product, person or service. Namely, it may include information not intended as explicitly promotional, similar to bonus features available on many DVDs, bibliographical material for various personalities, etc. The supplemental information may also include links to additional information that may be available to viewers.

For example, the supplemental information for a laptop shown within a certain program, could be the product type, model and the cost, and the supplemental information may include all technical parameters of the laptop, a tri-dimensional image, shipping and handling information, warranty information, etc. Or, the supplemental information for a performer (actor, athlete) may include the name and the most relevant appearances; with links to further information which may include biographical data, etc. and which may provide links to other programs featuring the performer. The supplemental information may include various levels of detail, e.g. simple identification, 30 second advertisement, 5-30 minute presentation, identification of local retailers,. etc. that the viewer can select between. In some instances, the supplemental information may include one or more links to additional information obtainable over the World Wide Web. The extent of the supplemental information available for viewing depends on the information provided by the advertiser. This supplemental information can be edited at any time. If, in the example, the laptop shown is obsolete, basic information on it can be provided along with links to current models. Or if there is a special limited time offer for a product, this can be advertised during the time of the offer.

The program may include an indication if supplemental information is available for the current point of the program. This may be in the form of an on-screen icon, which may further provide some form of indication of what type of information is available.

Finally, the term “broadcast network” refers to a network that connects the consumers with the entertainment content and the associated ads. The broadcast network can comprise TV, cable, streaming Internet, private networks, or any other mass-media broadcast. The broadcast network can charge a subscription fee for consumers to receive the entertainment and advertising content broadcast via the network. The invention is also applicable to systems supporting video on demand (VOD), including IPTV systems. The invention can furthermore be implemented to support video distribution by other means, including pre-recorded media.

Currently, a service provider includes commercials within a programming with a view to promote the advertisers products/services, in exchange for agreed-upon compensation. The basic idea of the invention is to keep records for each piece of supplemental information as to what locations in the program the information is relevant for. The location is a temporal measurement, and the location in the program is a range capturing the start and end of relevance or equivalently start and duration or any equivalent. The location measurement may be linear, as in time from beginning or frame number or it may be non-linear such as chapter or scene number, or it may be a hybrid such as time from the beginning of a given chapter. The location may also take the form of the location in the media file that is being read out.

The preferred implementation of the invention makes use of pre-existing location measurements; however the addition of a new location measurement mechanism is also covered by the invention. When a consumer requests supplemental information for something present at a given point in the program, the location in the program that the request was made at is compared to these records to find all relevant supplemental information. These records enable consumers to get linked with the supplemental information available for the respective product, person or service. For example, if a consumer wishes to find more about a car that is involved in a race in a program (a movie), a simple click while the car is on screen will provide a selection of links to available supplemental information relevant to that point of the program, including the car. It will be fast and easy to select the appropriate link. The availability of supplemental information to the viewer depends on the current location in the program that is being viewed and selected.

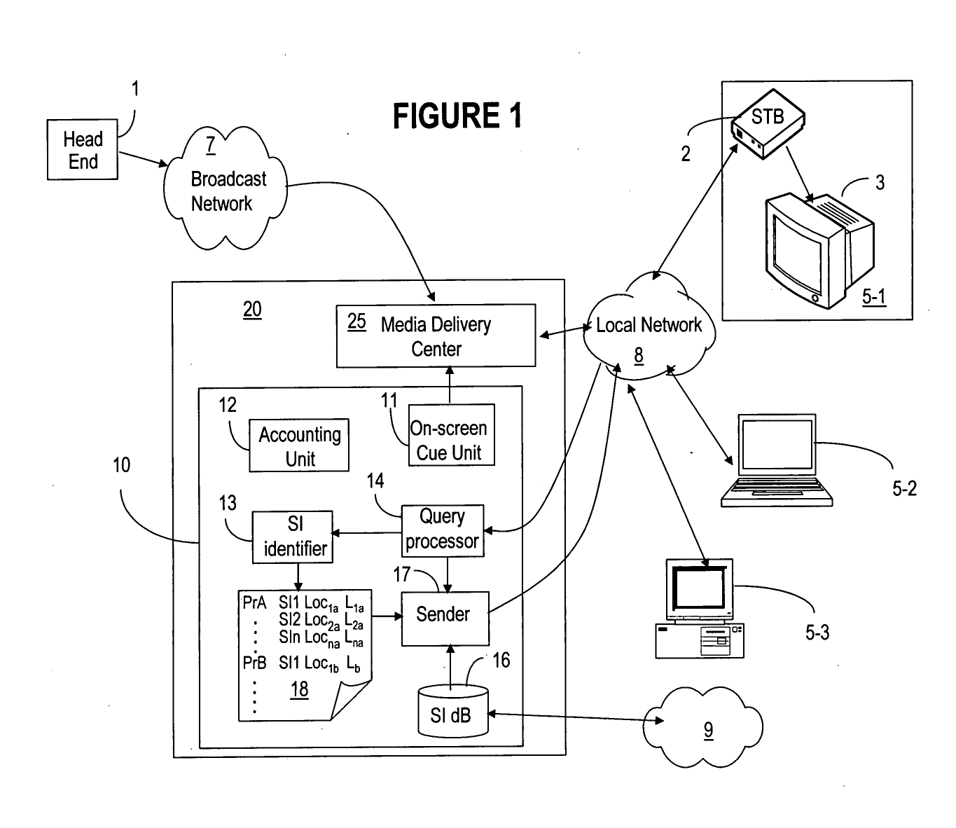

FIG. 1 illustrates a block diagram of the advertising with video programming system according to the invention. In the example of FIG. 1, the programming is provided from a head-end 1 to a local server 20 over a broadcast network 7. Local server 20 is equipped with a media delivery center 25 that performs the well known functionality of such a center for delivering video content to subscribers/consumers over a local network 8. The type of networks 7 and 8 is irrelevant to the invention.

The example of FIG. 1 also shows three consumer terminals 5-1, 5-2, and 5-3, where terminal 5-1 comprises a set-top box (STB) 2 and a TV set 3, terminal 5-2 is a laptop and terminal 5-3 is a PC. It is evident that the number of terminals is not limited to three, that the particular type of terminal is irrelevant to the invention, as other types of video terminals may be connected over the local network 8 to enable play-back of the video content streamed from the local server 20. Terminals 5-1, 5-2 and 5-3 enable trick-play (pause/rewind/fast forward/etc. of the programming) so that the user may stop the program and record it with a view to see and research an ad associated with the program, and continue seeing the program later or to record parts of interest of the program for researching the embedded commercials later. These terminals also allow the “bookmarking” of points in the program to allow the access of associated supplemental information at a later time. This may include supplemental information that has been associated with the program point at a time (i.e. real time, not program time) after the initial viewing of the program.

According to the invention, a supplemental information (SI) unit 10 is provided at the local server 20, for enabling the users in the geographical area served by local server 20 to access the available supplemental information of interest. Si server 10 provides access to the supplementary information to terminals 5-1, 5-2 and 5-3 or a RSS feed (not shown) on request. It is evident that a plurality of SI units 10 may be provided throughout network 7 for serving various local communities; also, a SI unit 10 may be located at the head end 1. If the SI units 10 are centralized, subscriber location information may be included in queries to allow for localized commercials. As indicated above, this information may refer to products and services provided of global interest (e.g. cars, computers, movies) or by local companies (e.g. specific retailers).

In all the above variants, after programming is developed, the supplemental information is associated with specific points or particular sections in the programming that direct the consumer to sources of information. The term “SI location” refers to the point or section within the programs that, when the consumer clicks, returns a particular supplemental information link. SI unit 10 includes a link database 16 that stores the supplemental information, and a table 18 that provides the association between the SI locations and the supplemental information links to the respective supplemental information. The entries may in addition contain an indicator of the type of information provided and/or what it is relevant to. It is to be noted that while FIG. 1 shows a table 18 which maintains the SI locations for a number of programs, a table per program may equally to be used. Also, a program may be broken down into a number of “chapters” and a table 18 may exist for each chapter or other division or a single table 18 may maintain the SI locations for each chapter or other division.

Table 18 in FIG. 1 shows the SI locations for a program A (a movie) denoted with PrA with n different instances where supplemental information is available. As seen in this example, the first supplemental information SI₁ is available at a location denoted with Loc₁; as indicated above, this point indicates the temporal location within the program which may be measured in a number of ways, with a preference for already existing measurements, e.g. many video players are able to indicate the elapsed time (or remaining time) of the program. Regardless of the actual measurement used (which could also be frame number or location within media file), the measurement is equivalent to time from the start of the program, and as such will be referred to as a time measurement. The location measurement available may be dependent upon the program type and viewer implementation; however translation will be mathematically simple and may take place during the generation of table 18 for the particular implementation or when the queries are received. Links denoted on table 18 with L₁ to Lₙ provide the link to the actual supplemental information kept in SI database 16.

One aspect of location translation separate from the metric used to measure the location occurs if the program is subject to different versions. For instance, the program may be edited for content such as removing scenes that may be objectionable to certain audiences. Or content may be inserted, for example conventional advertisements may be inserted into a broadcast program, and if the customer terminal is not able to automatically recognize the presence of the advertisements it will measure location as if it were a single program. The insertion or deletion of a known amount of content, at known points in the program, allows straight forward translation between locations in the edited program and the original program. The different versions of the program may be treated as different programs or a single table could be used with location translations used to compensate for deleted or added content.

In order to see/research a product/service, a consumer ‘clicks’ while a subject of interest is being presented (visually or audibly) in the program, using the channel selector or the mouse, etc. The click generates a query that arrives at a query processor 14 provided in the SI unit 10. In response to this action by the consumer, the consumer terminal (STB, PC, etc) or the SI unit, or both in cooperation determine the most recently viewed point of the program. FIG. 1 shows an embodiment where the query-processor determines the program being viewed, the location of the query within the program (henceforth referred to as program time), and identifies the consumer terminal that generated the query.

The program time of the query, denoted with T_{Q} is used to identify entries in the table 18, as shown by a SI identifier unit 13. The SI unit 13 signals the location of the query within the program using the same metric as the entries in table 18. In any case, the SI location for that query is identified by unit 13 is used to determine which supplemental information links are available for the respective SI location. These are delivered to the consumer for selection. It is possible to have entries which match to any time index, i.e. they are relevant for the entire program. It is also possible to allow the consumer to send a query for supplemental information that is relevant for any point in the program, regardless of time index. This can be extended to allow the configuration of certain pieces of supplemental information to not be accessible by such a general query, for scenarios in which it is desired for the customer to view the program rather than only access the supplemental information. For instance, a training program could require access to supplemental links that can only be accessed while viewing the program in order to ensure the viewer watched the program. Or a contest could make use of supplemental links and it would not be possible to simply view all available links, it would be necessary to view the program.

A sender 17 is used to provide the link information to the consumers. Sender 17 is also used to deliver to the consumer terminal the supplementary data requested from the SI database 16. It is noted here that the supplemental information in database 16 may include additional links that direct the consumer to more detailed information, if of interest. This is generically shown by the network 9, which may be for example the Internet with its wealth of information, or may be a private network managed by the advertiser, etc. The extent of information provided in database 16 it at the discretion of the advertiser, as is the availability of any additional links. A further ability is for the SI accessed from the database 16 to provide a generic link, which provides links to specific advertisers which are relevant to the generic link. This allows multiple (potentially competing) advertisers to be accessed through a single entry in table 18. It also allows the connection between an advertiser or advertisers and content to be made without editing the entries in table 18 for each program.

The SI unit 10 may also be equipped with an accounting unit 12 that monitors use of commercials for establishing a revenue value for each program according to the usage of the supplemental information. The usage may be determined based on any charging model (e.g. pay per click, or per time, numbers of queries, downloading time, etc.). In the case of advertisements, the charges would tend to go to the advertisers, in the case of other supplemental information charges could apply to viewers, no charge access is also an option.

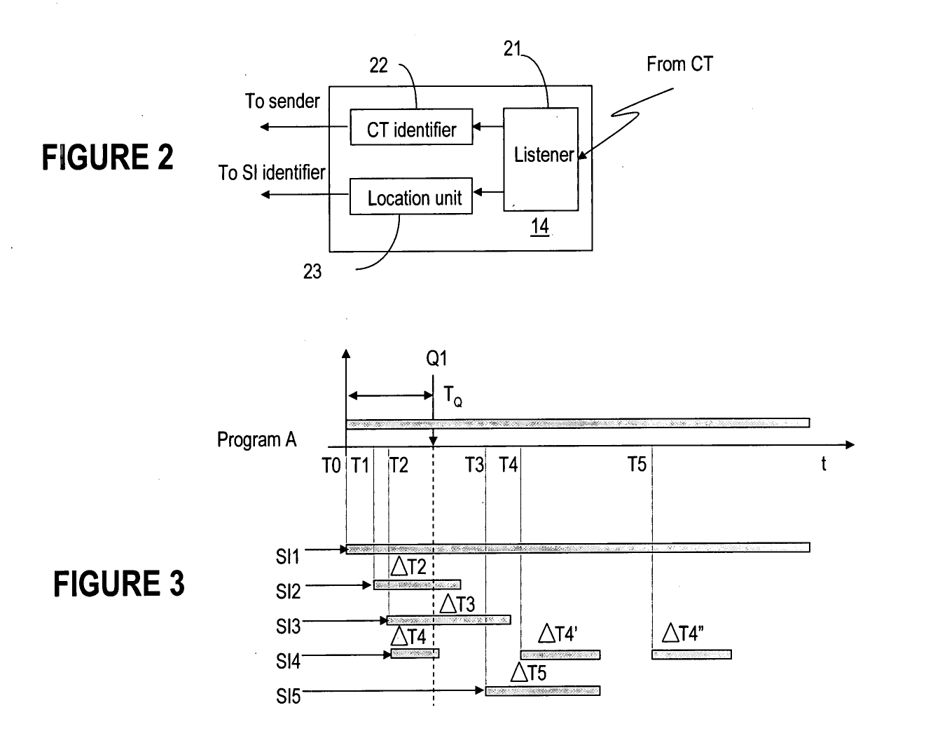

FIG. 2 illustrates the block diagram of an embodiment of the query processor 14. The query processor includes a listener 21 for detecting all queries generated by the consumer terminals 5-1 to 5-3, a consumer terminal identifier 22 that associates the query with the terminal that generated it, and a location unit 23. Location unit 23 identifies the associated program and location in said program of the respective query, which is provided to the SI identifier unit 13, for enabling it to determine the correct entry into table 18. The location may be determined solely based on information in the query from the CT. Alternatively, the location may be determined based on combined information in the query and information available in the local server. This server based information may include information on program playback from the Media Delivery Center 25. The information may also include information required to translate the location from the format in the query to the format used in table 18.

Other embodiments of the SI unit 10 are possible. For example, STB 2 provides the time-mark in the program of the query. Another variant is for the query processor 14 may send the link to the media delivery center for transmission to the terminal, and use a programming sender for delivery of the supplemental information, in which case sender 17 is not needed. Also, the query may be detected by the media delivery center 20, which is customary equipped with an interactive program guide unit (not shown); in this case, the media delivery center 20 identifies the queries as being related to requests for supplemental information, and provides the time of arrival information directly to SI identifier 13. In all variants, SI unit 13 identifies the relevant entries in table 18 based on the time of the query relative to the beginning of the program, or relative to some known part of the program.

It is also possible to configure the consumer terminal (STB or other implementation) to provide on screen cues when supplemental information is available. In the example of FIG. 1, an on-screen cue unit 11 is used for inserting cues indicating to the consumer that the respective view enables obtaining of supplemental information. The cues may be just a simple mark, or may be more complex cue in that it may provide specifics on the type of SI available (e.g. a commercial, or biographic data), etc. Alternatively, the program may have on screen cues inserted at the media delivery center. A further alternative is to add on screen cues to programs stored at the local server or elsewhere in the network. Changes in the supplemental information would require modification to the stored version with the on screen cues.

The example of FIG. 3 shows the how the supplemental information is associated with a program PrA, which includes links to SI₁ to SI₅, with the relevance marked relatively to the start of the program PrA, which is time T0. Please note that the time is one of the ways the correlation between the supplement information and the program can be made. As indicated above, the frame number may equally be used, or any other way of marking the point/section in the program which is associated with SI. It is also possible to enable the consumers to access the same supplemental information at multiple points during a program. As an alternative to the time window ΔT, the end point of the window may be stored.

In the examples shown in FIG. 3, supplemental information SI₁ is associated to the entire program A, from T0 to the end of the program. For example, if the program is a movie, the link L₁ associated with SI₁ directs the consumers to general information about the movie, such as the cast, director, award, rating, etc., whenever he/she clicks on any scene during the movie playback. Let's further assume that SI₂ provides information about some cars (make, year, etc), and the SI location identifies a sequence extending from T1 for a relevant time of ΔT2; the consumer shows interest in the cars participating in the race by clicking during ΔT1, the link L₂ leading to the actual SI₂ which will be returned to the consumer. Further, availability of supplemental information SI₃ extends over a sequence of length ΔT3 starting at T2, and may for example provide a link L₃ to information about a certain museum shown in that sequence. As seen for example in the case of SI₄, the supplemental information is available at three instances (T2, T4 and T5) during the course of program A, each extending over a different time range for each instance, here ΔT4, ΔT4′ and ΔT4″. The actual table implementation may for this case have three entries, each with the same link, or the table may allow the association of more than one location with a given entry.

FIG. 3 also illustrates how the information associated with a certain commercial is correlated with the time T_{q} when a consumer query is received at SI unit 10. If the time of arrival of query Q1 is T_{Q} after the beginning of the program PrA, SI unit 13 accesses table 18 and determines which entries are relevant at time T_{Q}. This results in L₁, L₂, L₃ and L₄ being returned to the requestor. These links are sent to the consumer terminal that issued the query, using sender 17. Once the consumer receives the links, he/she may select which if any of the links are of interest for further investigation. The link(s) of interest may be stored and the program may be resumed, or viewing of the program may be suspended while the consumer follows the link. Also, the location within the program of the query may be stored and the program resumed. Supplemental information for the query location may be reviewed and investigated at a later time, at which more information may be available.

In the embodiment described above, the consumer clicks on an image with an expectation to get information about a product/service. If no commercial or information is available for the respective sequence playing back on the consumer's display, the consumer may be given the option of bookmarking the location. The process of bookmarking may involve the sending of a permanent (direct) location value to the CT, in case the program is subject to multiple versions. It is possible to configure the consumer terminal (STB, PC) to display on-screen cues when supplemental information is available, by using the on-screen cue unit 11, as discussed above in connection with FIG. 1.

This invention enables a large number of products/services to be “advertised” simultaneously—ultimately almost anything on the screen, anything being heard (i.e. music track) or discussed. Still further, this mechanism may be used to access non-program related advertising, in which a supplemental information link may allow connections to advertising not related to the program being viewed. This is particularly suited to local advertising (e.g. “Hmmm, I'm hungry, what are my choices?”). While this is similar in effect to accessing a web browser to search for information on the web, it does not require the consumer to use a different interface.

I claim:

1. A system for associating supplemental information from a local server with a program distributed to consumer terminals, comprising at said local server:
a table for maintaining an association between a supplemental information link and a SI location within said program where the linked supplemental information is accessible;
a query processor for receiving a query from a consumer terminal and determining the time location within the program of said query and identifying a consumer terminal (CT) that issued said query; and
a supplemental information identifier for identifying in said table said supplemental information link based on the time location, within the program, of said query.

2. A system as claimed in claim 1, further comprising:
a supplemental information database for maintaining said supplemental information; and
a sender for transmitting said supplemental information link to said consumer terminal and for transmitting said supplemental information provided by said supplemental information database, using said supplemental information link.

3. A system as claimed in claim 1 further comprising an accounting unit for establishing a revenue value according to the usage of said supplemental information associated to said program.

4. A system as claimed in claim 1 further comprising an on-screen cue unit for inserting a video cue at said SI location within said program for indicating availability of said supplemental information on said consumer terminal.

5. A system as claimed in claim 4, wherein said video cue further indicates specifics on the type of said supplemental information.

6. A system as claimed in claim 1, wherein said supplemental information link provides additional links to further supplemental information.

7. A system as claimed in claim 1, wherein said SI location is defined in said table by the amount of the program that elapses before the supplemental information is accessible and the amount of program that elapses after which the supplemental information is no longer accessible.

8. A system as claimed in claim 7, wherein the amount of program that elapses is measured in terms of viewing time.

9. A system as claimed in claim 7, wherein the amount of program that elapses is measured in terms of viewing time relative to markers within the program.

10. A system as claimed in claim 1, wherein said table further includes comments regarding said supplemental information, for display on said consumer terminal together with said supplemental information link.

11. A system as claimed in claim 1, wherein said query processor includes means for listening for queries transmitted by said consumer terminals, means for identifying said consumer terminal that issued said query and means for determining the time within the program of said query.

12. A method of associating supplemental information from a local server with a program distributed to consumer terminals, comprising:
maintaining a table with an association between a SI location within said program where supplemental information is available and a supplemental information link;
receiving a query from a consumer terminal and determining the time location within the program of said query;
identifying said consumer terminal that issued said query; and
identifying in said table said supplemental information link based on the time location of said query.

13. A method as claimed in claim 12, further comprising transmitting said supplemental information link to said consumer terminal for enabling access to said supplemental information provided by said supplemental information link.

14. A method as claimed in claim 12, further comprising transmitting said supplemental information to said consumer terminal on request.

15. A method as claimed in claim 12, further comprising establishing a revenue value according to the usage of said supplemental information associated to said program.

16. A method as claimed in claim 12, further comprising providing a video cue within said program for indicating availability of said supplemental information.

17. A-method as claimed in claim 12, wherein said SI location of said supplemental information within said program is identified in said table by a starting time and a time range.

18. A method as claimed in claim 17, wherein said supplemental information link is identified in said table by comparing said time of arrival with said starting time and said time range.

19. A method as claimed in claim 12, wherein said table is generated using user profiles maintained at said local server, for associating said supplemental information to said program according to said program genre.

20. A consumer terminal enabled with trick play capabilities for interactive access to supplemental information associated with a program transmitted from a head end to a local server over a broadcast network, comprising:
a sender for transmitting a query for supplemental information;
a receiver for receiving a supplemental information link in response to said query;
means for storing said supplemental information link; and
means for signaling to a source of said supplemental information to deliver said supplemental information that is associated with said supplemental information link.
